(19) United States
(12) Patent Application Publication
(10) Pub. No.: US 2010/0227130 A1
(43) Pub. Date: Sep. 9, 2010

(54) MOLDED ARTICLE FORMED OF HIGHLY ELASTIC FIBER BALLS

(75) Inventor: Hideharu Takahashi, Osaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SOLOTEX CORPORATION, Osaka-shi, Osaka (JP)

(21) Appl. No.: 12/159,132

(22) PCT Filed: Dec. 14, 2006
(86) PCT No.: PCT/JP2006/325447

§ 371 Date: Jun. 25, 2008

(30) Foreign Application Priority Data
Dec. 26, 2005 (JP) 2005-371471

(51) Int. Cl. B32B 7/04

(52) U.S. Cl. 428/196

(57) ABSTRACT

A molded article formed of highly elastic fiber balls and obtained by thermoforming fiber balls in a mold, characterized in that each fiber ball is composed of a conjugate short fiber (a) defined below and a poly(trimethylene terephthalate) short fiber (b), and that part of the fiber interlaced points of fibers of each fiber ball are thermally fixed with flexible thermally fixed points:
(a) a conjugate short fiber wherein a nonelastic polyester and an elastic thermoplastic elastomer having a melting point lower than that of the nonelastic polyester by 40° C. or more are combined, and the nonelastic polyester is exposed to occupy from 25 to 49% of the surface area of the conjugate short fiber.

### FIELD OF THE INVENTION

The present invention relates to a molded article formed of highly elastic fiber balls, being soft, having high repulsion, having high resistance to washing and being resistant to stiffening.

### BACKGROUND ART

A polyester short fiber has been used as a filling material for bedding, pillows, cushions, and the like. A method comprising opening a polyester short fiber by carding, or the like, to form webs, stacking the webs in layers to form a sheet, and covering the sheet with a side fabric has been well known as a filling method. However, it takes a lot of time to cover the stacked webs in layers by the filling method, and the cushion material thus obtained has a strong thickness direction. The cushion material thus obtained is therefore not preferable. On the other hand, for example Japanese Unexamined Patent Publication (Kokai) No. 56-85453, discloses as a method of improving the operability and canceling the direction of the cushion material, a method comprising filling fiber particles in a side fabric by a procedure such as blowing. However, the resultant cushion material has the following disadvantages: a stiff feeling; the fibers in the cushion material are likely to move and be permanently set during use because there are no bonded points among the fibers. Moreover, Japanese Unexamined Patent Publication (Kokai) No. 61-125377 discloses a method comprising blowing ball-like short fiber containing a binder fiber into a side fabric, and then heat treating the ball-like short fiber. Because heat treatment is conducted after blowing, each ball-like short fiber cannot be separately moved, and cannot be moved and deformed separately during use. The shape to be used of the cushion material cannot be easily changed, and the cushion material has a stiff feeling and poor elasticity and elastic recovery. Furthermore, the cushion material disclosed in Japanese Unexamined Patent Publication (Kokai) No. 10-259559 shows excellent compression durability because a loop-like nonelastic polyester is used; however, it has a stiff feeling. In addition, Japanese Unexamined Patent Publication (Kokai) No. 10-259559 neither describes nor suggests the use of a poly(trimethylene terephthalate) short fiber as the loop-like nonelastic polyester.

### DISCLOSURE OF THE INVENTION

The present invention provides a molded article formed of highly elastic fiber balls. The molded article has a soft feeling, is excellent in elasticity and compression durability, and has form stability.

The present invention relates to a molded article formed of highly elastic fiber balls and obtained by thermoforming fiber balls in a mold, characterized in that each fiber ball is composed of a conjugate short fiber (a) defined below and a poly(trimethylene terephthalate) short fiber (b), and that part of the fiber interlaced points of fibers of each fiber ball are thermally fixed with flexible thermally fixed points:

(a) a conjugate short fiber wherein a nonelastic polyester and an elastic thermoplastic elastomer having a melting point lower than that of the nonelastic polyester by 40° C. or more are combined, and the nonelastic polyester is exposed to occupy from 25 to 49% of the surface area of the conjugate short fiber.

For the molded article formed of highly elastic fiber balls according to the present invention, the following are preferred: the poly(trimethylene terephthalate) short fiber (b) is a conjugate fiber formed by bonding two components in a side-by-side manner or in an eccentric core-sheath manner; at least one component is a poly(trimethylene terephthalate); and latent crimp is manifested.

For the molded article formed of highly elastic fiber balls according to the present invention, the individual fiber thickness of the poly(trimethylene terephthalate) short fiber (b) is preferably from 1 to 7 dtex.

For the molded article formed of highly elastic fiber balls according to the present invention, the 25% Indentation Load Deflection (ILD) measured in accordance with JIS K6401 is preferably 11 N or less.

For the molded article formed of highly elastic fiber balls according to the present invention, the linearity measured during measuring the hardness in accordance with JIS K6401 is preferably 40% or less.

For the molded article formed of highly elastic fiber balls according to the present invention, the strain measured on the basis of a change in thickness in accordance with JIS K6401, after washing three times specified by JIS L0217-103 is preferably 5% or less.

For the molded article formed of highly elastic fiber balls according to the present invention, the molded article can form bedding, a pillow, a cushion or a seat.

The molded article formed of highly elastic fiber balls according to the present invention has a soft feeling, is excellent in elasticity and compression durability, and has form stability.

### BRIEF DESCRIPTION OF THE DRAWINGS

FIG. 1 is a schematic view showing a cross section of a conjugate short fiber, wherein E designates an elastic thermoplastic elastomer, P designates a nonelastic polyester, A designates the length of an exposed portion of E, B designates the length of an exposed portion of P, L_{E} designates the maximum thickness of E, L_{P} designates the maximum thickness of P, L designates a linear distance connecting the contact points (P₁ and P₂) of P and E in the periphery of P and E, and C designates the length of a curve formed by the contact of P with an unexposed portion of E.

FIG. 2 is a cross-sectional view showing one embodiment of an apparatus for thermoforming a molded article out of fiber balls.

FIG. 3 is a model graph showing the relationship between a change in thickness and an ILD. In FIG. 3, A, B and C designate an initial load, a turn-around point and an indentation distance, respectively. The linearity is calculated from the following formula.

Linearity (%)=(area of AaBC)/(area of AbBC)×100

### BEST MODE FOR CARRYING OUT THE INVENTION

The highly elastic fiber balls out of which the molded article of the present invention is formed are each composed of (a) the above conjugate short fiber wherein a nonelastic polyester and an elastic thermoplastic elastomer having a melting point lower than that of the nonelastic polyester by 40° C. or more are combined, and the nonelastic polyester is exposed to occupy from 25 to 49% of the surface area of the conjugate short fiber (hereinafter also termed “conjugate short fiber (a)”) and (b) the poly(trimethylene terephthalate) short fiber (also termed “poly(trimethylene terephthalate) short fiber (b)”).

(a) Conjugate Short Fiber

Although the nonelastic polyester used for the conjugate short fiber (a) of the present invention is satisfactory as long as the nonelastic polyester is a polyester and a nonelastic polymer, examples of the nonelastic polyester include poly(ethylene terephthalate), poly(butylene terephthalate), poly(hexamethylene terephthalate), poly(tetramethylene terephthalate), poly(trimethylene terephthalate), poly(1,4-dimethylcyclohexane terephthalate) and polypivalolactone that are conventional, or a polymer composed of these copolymerized esters. For applications in which strain is repeatedly applied, poly(butylene terephthalate) that does not leave a strain is preferred. In particular, when the hard segment of an elastomer used as the melt-sticking component of the conjugate fiber is a poly(butylene terephthalate), a problem such as peeling does not arise.

Furthermore, any elastic thermoplastic elastomer may be used for the conjugate short fiber (a) of the invention as long as the thermoplastic elastomer has a melting point lower than that of the nonelastic polyester by 40° C. or more. However, in view of the proper spinnability and physical properties, a polyurethane elastomer or a polyester elastomer is preferred.

Of these, examples of the polyurethane elastomer include a polymer obtained by the reaction of a low melting point polyol having a molecular weight of from about 500 to 6,000 such as a dihydroxypoly ether, a dihydroxypolyester, a dihydroxypolycarbonate or a dihydroxypolyester amide, with an organic diisocyanate having a molecular weight of 500 or less such as p,p′-diphenylmethane diisocyanate, tolylene diisocyanate, isophorone diisocyanate, hydrogenated diphenylmethane diisocyanate, xylylene diisocyanate, 2,6-diisocyanatomethyl caproate or hexamethylene diisocyante, and a chain extender having a molecular weight of 500 or less such as a glycol, an aminoalcohol or a triol. Of these polymers, particularly preferred ones are a poly(tetramethylene glycol) or a poly-ε-caprolactone. p,p′-Diphenylmethane diisocyanate is appropriate as the organic diisocyanate. Moreover, p,p′-bis(hydroxyethoxy)benzene and 1,4-butanediol are appropriate as the chain extenders.

On the other hand, a polyether ester block copolymer produced by copolymerizing a thermoplastic polyester as a hard segment and a poly(alkylene oxide) glycol as a soft segment is used as the polyester elastomer. More specifically, the polyester elastomer is a terpolymer composed of (1) at least one dicarboxylic acid selected from aromatic dicarboxylic acids such as terephthalic acid, isophthalic acid, phthalic acid, naphthalene2,6-dicarboxylic acid, naphthalene-2,7-dicarboxylic acid, diphenyl-4,4-dicarboxylic acid, diphenoxyethanedicarboxylic acid and sodium 3-sulfoisophthalate, alicyclic dicarboxylic acids such as 1,4-cyclohexanedicarboxylic acid, aliphatic dicarboxylic acids such as succinic acid, oxalic acid, adipic acid, sebacic acid, dodecanedicarboxylic acid and dimeric acid, or ester derivatives of these dicarboxylic acids, (2) at least one diol component selected from aliphatic diols such as 1,4-butanediol, ethylene glycol, trimethylene glycol, tetramethylene glycol, pentamethylene glycol, hexamethylene glycol, neopentyl glycol and decamethylene glycol, alicyclic diols such as 1,1-cyclohexanedimethanol, 1,4-cyclohexanedimethanol and tricyclodecanedimethanol, or ester derivatives of these diols, and (3) at least one poly(alkylene oxide) glycol having an average molecular weight of from about 400 to about 5,000 such as a poly(ethylene glycol), a poly(1,2- and 1,3-propylene oxide) glycol, a poly(tetramethylene oxide) glycol, a copolymer of ethylene oxide and propylene oxide and a copolymer of ethylene oxide and tetrahydrofuran.

Of these, a polyester elastomer is preferred in view of the physical properties such as adhesion to the polyester conjugate component, heat resistance and strength, and the like, and a block copolymerized polyether polyester in which a poly(butylene terephthalate) and a poly(oxytetramethylene glycol) are made a hard segment and a soft segment, respectively, is particularly preferred. In this case, the polyester portion consisting of the hard segment is a poly(butylene terephthalate) wherein the main acid component is terephthalic acid, and the main diol component is butylene glycol. Part of the acid component (usually 30% by mole or less) may naturally be replaced with another dicarboxylic acid component and another oxycarboxylic acid component. Similarly, part of the glycol component may be replaced with a dioxy component other than a butylene glycol component. Moreover, the polyether component consisting of the soft segment may also be a polyether in which the tetramethylene glycol component is replaced with another dioxy component.

In addition, various stabilizers, UV absorbers, thickening and branching agents, delustering agents, coloring agents and other various improvers may also be optionally incorporated into the elastic thermoplastic elastomer such as a polyurethane or polyester elastomer.

Of the above elastic thermoplastic elastomers, a polyester elastomer excellent in thermal stability is particularly preferred because it forms melt-sticking bonded points by heat treatment after web formation.

The conjugate short fiber (a) used in the present invention is formed by conjugating the nonelastic polyester fiber and the thermoplastic elastomer having a melting point lower than that of the nonelastic polyester. The nonelastic polyester is required to be exposed on the fiber surface in an area of from 25 to 49%, preferably from 28 to 40%. When the exposure is low, fibers are likely to melt together and be compression bonded resulting in problems during the production of the conjugate fiber. Moreover, because the polymer is soft, the conjugate short fiber twines around or sticks to a rotating garnet wire used for opening and short fiber blending in the preparation of fiber balls. As a result, the cardability of the short fiber becomes poor, and long-term operation of the production line becomes difficult, or uniform bulky blended short fiber is difficult to obtain. Moreover, because adhering portions are increased, the conjugate short fiber is likely to form many thermally fixed points with the surrounding fibers and a fine network structure is formed; the resultant fiber balls show less elasticity. On the other hand, when the exposure is excessively large, the area covered with the hot melt-sticking component of the conjugate short fiber surface is decreased; as a result, adhesion of the thermoplastic elastomer does not take place, and the elasticity and durability of the conjugate short fiber is decreased.

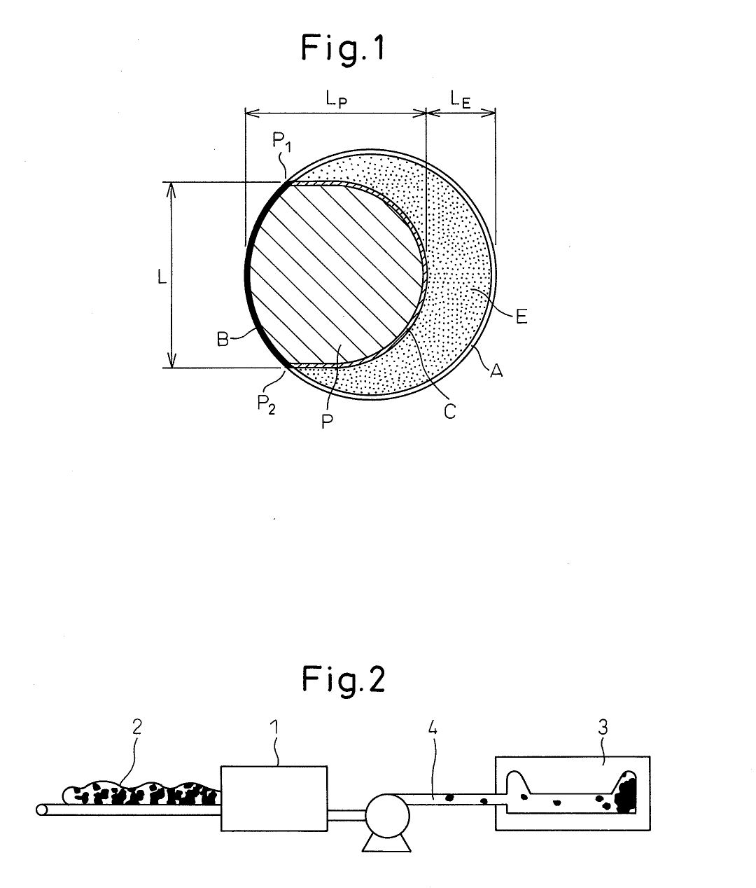

In addition, for the nonelastic polyester and the elastic thermoplastic elastomer, the two components are preferably conjugated and bonded in the fiber cross section with a curvature (ratio of C/L in the fiber cross section in FIG. 1, wherein C is a boundary length of the adhered portion, and L is a line segment connecting the exposed points of the nonelastic polyester P) of preferably from 1.1 to 2.5, more preferably from 1.2 to 2.0. The curvature near 1 (close to a line segment) is not preferred for the following reasons: the two polymers are likely to separate; manifestation of crimp becomes poor; manifestation of crimp becomes poor during heat treatment, and a fiber ball is difficult to form; formation of flexible thermally fixed points with the nonelastic crimped short fiber enfolded becomes difficult. On the other hand, an excessively large curvature is not preferred for the following reasons: the crimp becomes excessively large; the crimp is likely to be produced easily during heat treatment; the bulkiness of the fiber ball is decreased, and an uneven feel is produced.

Furthermore, the thickness ratio in a thick portion in a cross section of the two polymers (the ratio of a maximum thickness (Lₚ) of the nonelastic polyester in the core portion of the conjugate short fiber to a maximum thickness (L_{E}) of the elastic thermoplastic elastomer Lₚ/L_{E} in FIG. 1) is preferably from 1.2 to 3.0, more preferably from 1.5 to 2.9. The thickness ratio close to 1 is not preferred for the following reasons: manifestation of crimp becomes poor; manifestation of crimp during heat treatment becomes poor; similarly, the conjugate short fiber hardly makes a ball; fusion of the thermoplastic elastomer with the nonelastic crimped short fiber enfolded does not easily take place. On the other hand, an excessively large thickness ratio is not preferred for the following reasons: the crimp becomes excessively large; when the fiber is heat treated, crimping is likely to easily take place, and the bulkiness becomes poor (fiber having an uneven feeling).

When the curvature and the thickness ratio are not proper, the crimp of the fiber during ball formation of the fiber becomes improper, and the fiber hardly makes a ball. As a result, the following process is difficult to carry out: flexible thermally fixed points are produced to make a firm structure while the crimp is being manifested by heat treatment and a poly(trimethylene terephthalate) short fiber (nonelastic polyester short fiber) is being enfolded.

Furthermore, the area ratio of the nonelastic polyester to the elastic thermoplastic elastomer in the fiber cross section of the conjugate short fiber is preferably from 25/75 to 75/25, more preferably from 30/70 to 65/35. When the ratio is excessively small, the flexible thermally fixed points in the fiber ball become excessively tough, and the fiber ball cannot exhibit elasticity. As a result, durability and elasticity of the fiber ball cannot be expected. On the other hand, when the ratio is excessively high, the flexible thermally fixed points of the fiber becomes excessively firm, and the fiber ball cannot exhibit elasticity; or the fibers at a crossing point are not likely to be deformed, and a phenomenon that fibers around the crossing point are strained or destroyed occurs. In other words, the durability of the fiber ball is lowered.

The individual fiber thickness of the conjugate short fiber (a) explained above is from 2 to 100 dtex, preferably from 4 to 100 dtex.

(b) Poly(trimethylene terephthalate) Short Fiber

The poly(trimethylene terephthalate) short fiber used in the present invention designates a polyester short fiber in which a trimethylene terephthalate unit is a principal repeating one. The poly(trimethylene terephthalate) short fiber contains trimethylene terephthalate units in an amount of about 50% by mole or more, preferably 70% by mole or more, more preferably 80% by mole or more, particularly preferably 90% by mole or more. The poly(trimethylene terephthalate) short fiber therefore contains as a third component another acid component and/or another glycol component in a total amount of about 50% by mole or less, preferably 30% by mole or less, more preferably 20% by mole or less, particularly preferably 10% by mole or less.

The poly(trimethylene terephthalate) is produced by condensation of terephthalic acid or its functional derivative, and trimethylene glycol or its functional derivative under suitable reaction conditions in the presence of a catalyst. In the production process, suitable one or at least two types of third components may be added to produce a copolymerized polyester. Alternatively, a polyester other than a poly(trimethylene terephthalate) such as a poly(ethylene terephthalate), a nylon, or the like, may also be produced separately from the poly(trimethylene terephthalate). The resultant polymer and the poly(trimethylene terephthalate) may also be blended or conjugate spun (sheath-core, side-by-side, or the like).

Examples of the third component to be added include aliphatic dicarboxylic acids such as oxalic acid and adipic acid, alicyclic dicarboxylic acids such as cyclohexanedicarboxylic acid, aromatic dicarboxylic acids such as isophthalic acid and sodiosulfoisophthalic acid, aliphatic glycols such as ethylene glycol, 1,2-propylene glycol and tetramethylene glycol, alicyclic glycols such as cyclohexane glycol, aromatic dixoy compounds such as hydroquinone bisphenol A, aliphatic glycols containing an aromatic group such as 1,4-bis(β-hydroxyethoxy)benzene, and aliphatic oxycarboxylic acids such as p-oxybenzoic acid. Moreover, compounds containing one or at least three ester-forming functional groups such as benzoic acid or glycerin can also be used as long as the polymer is substantially linear.

In addition, a poly(trimethylene terephthalate) usually has an intrinsic viscosity of from 0.5 to 1.6 dl/g. The intrinsic viscosity is a value measured in o-chlorophenol at 35° C. When the intrinsic viscosity is less than 0.5 dl/g, the fiber finally obtained has an insufficient mechanical strength. On the other hand, when the intrinsic viscosity exceeds 1.6 dl/g, the handleability of the fiber unpreferably becomes poor. The intrinsic viscosity is preferably from 0.55 to 1.5 dl/g, more preferably from 0.55 to 1.45 dl/g, still more preferably from 0.6 to 1.4 dl/g.

Furthermore, the poly(trimethylene terephthalate) may also be made to contain delustering agents such as titanium dioxide, stabilizing agents such as phosphoric acid, UV absorbers such as a hydroxybenzophenone derivative, crystallization nucleating agents such as talc, sliding agents such as aerosil, antioxidants such as a hindered phenol derivative, flame retardants, antistatic agents, pigments, fluorescent brighteners, IR absorbers, defoaming agents, and the like.

In addition, the above poly(trimethylene terephthalate) short fiber used in the invention is a conjugate fiber in which two components are bonded in a side-by-side manner or in an eccentric core-sheath manner. At least one component of the short fiber is a poly(trimethylene terephthalate), and the short fiber having manifested latent crimpability is also preferably used.

Examples of such a latently crimpable poly(trimethylene terephthalate) short fiber include (1) to (2) mentioned below.

(1) A latently crimpable conjugate short fiber (see Japanese Unexamined Patent Publication (Kokai) No. 2000-256918) in which a poly(trimethylene terephthalate) (A) having no three-functional copolymerization component, and a poly(trimethylene terephthalate) (B) (in which three-functional copolymerization components such as trimethylolpropane, pentaerythritol, trimellitic acid or pyromellitic acid are copolymerized in an amount of from 0.05 to 0.2% by mole) or a poly(trimethylene terephthalate) (C) having an intrinsic viscosity lower than that of (A) mentioned above by 0.15 to 0.3 are conjugated in a side-by-side manner or in an eccentric sheath-core manner.

(2) A polyester conjugate fiber (see Japanese Unexamined Patent Publication (Kokai) No. 2001-288621) produced by conjugating a poly(trimethylene terephthalate) polyester A with an intrinsic viscosity of from 0.9 to 1.5 and a poly(ethylene terephthalate) polyester B with an intrinsic viscosity of from 0.3 to 0.7 in a weight ratio of A:B=30:70 to 70:30 in a side-by-side manner or in an eccentric core-sheath manner, and showing a total crimp ratio of from 15 to 50% and a boil-off shrinkage of from 7 to 15%.

When a fiber is prepared from such polymers, a known anisotropic cooling spinning method is preferably carried out. In the method, directly after injecting a molten polymer through a spinneret, cooling air is blown to the spun fiber from one direction to cool it. A difference in crystal orientation may be imparted to the fiber cross-sectional direction. The undrawn fiber thus obtained is drawn by known hot water two step drawing. The drawn fiber is cut at a given length, and the cut fiber is relaxation heat treated to give a short fiber to which three-dimensional steric crimp has been imparted.

The short fiber (to which steric crimp is imparted) compared with a conventional indentation crimped short fiber is bulky and has the advantage that even a nonwoven fabric prepared therefrom has significantly excellent properties such as cushioning.

The poly(tetramethylene terephthalate) short fiber (b) used in the present invention has a thickness of preferably from 1 to 100 dtex, more preferably from 2 to 50 dtex, particularly preferably from 1 to 7 dtex. When the thickness is less than 1 dtex, the following disadvantages results: the bulkiness is not exhibited; when the short fiber is blown into a side fabric with air, or the like, the short fiber is hardly blown thereinto uniformly due to compression; the molded article thus obtained such as a cushion material shows poor cushioning properties and poor repulsive force. On the other hand, when the thickness exceeds 100 dtex, the fiber cannot be bent easily so that balls are not likely to be formed. The number of constituent fibers of the fiber ball thus obtained becomes too small, and the feeling becomes stiff.

In addition, the poly(trimethylene terephthalate) short fiber (b) is preferably surface treated with smoothing agents so that the fiber becomes slippery. When the surface becomes slippery, the fiber ball is easily formed with a turbulent airflow, or the like. Moreover, the fiber balls thus obtained have a soft feeling, and a feather feeling or a feather touch feeling is easily obtained. Any of these agents may be used as long as the short fiber becomes slippery, when the agent is imparted and the short fiber is dried or subjected to hardening treatment. For example, the surface friction of the short fiber may be decreased by covering the short fiber with a segmented polymer of a poly(ethylene terephthalate) and a poly(ethylene oxide). Furthermore, because the smoothness of the short fiber is significantly improved, imparting to the short fiber as a smoothing agent of a silicone resin at an optional stage a treating agent principally containing a silicone resin such as a dimethylpolysiloxane, an epoxy-modified polysiloxane, an amino acid-modified polysiloxane, a methylhydrogenpolysiloxane or a methoxypolysiloxane is preferred. An application amount of from 0.1 to 0.3% by weight is usually suitable. It is naturally often necessary to add an antistatic agent to a silicone resin or treat the short fiber with an antistatic agent after silicone resin treatment in order to prevent friction between the short fiber and air during the formation of a fiber ball and generation of static electricity produced by air turbulence flow treatment at high temperature during melt sticking treatment.

Such a treatment with a smoothing agent generally hinders melt sticking of the short fiber to a low melting point fiber. The short fiber relatively well melt sticks to the elastic thermoplastic elastomer making the conjugate fiber (a), and in addition can enfold the poly(trimethylene terephthalate) short fiber relatively well in the form to increase the adhesion strength apparently. Such action is naturally insignificant when a conventional low melting point conjugate fiber alone is used.

In the present invention, the blending ratio of the poly(trimethylene terephthalate) short fiber (b) is preferably from 95 to 51% by weight, more preferably from 90 to 55% by weight. When the blending ratio is excessively high and an amount of the conjugate short fiber (a) that is a melt-sticking one is small, the repulsion is insignificant because bonded points decrease, and the form stability becomes poor. On the other hand, when the blending ratio is excessively low, the number of bonded points becomes excessive, and use of the fiber balls as a cushion material causes problems because the fiber balls become stiff. Moreover, as will be described later, during formation of melt-sticking points by heat treatment, because melt sticking bonded points are produced while crimp is being manifested, the fiber ball becomes highly dense to produce still more unpreferable results.

In the present invention, the conjugate short fiber (a) and the poly(trimethylene terephthalate) short fiber (b) that is a nonelastic short fiber, both fibers having specific conditions, are short fiber blended, and a fiber ball is formed by a method to be described later. When the nonelastic short fiber and fluff of the nonelastic fiber are present on each fiber ball surface in large amounts, blowing the fiber balls is well conducted, and the cushion feeling after blowing the fiber balls becomes very excellent due to the contribution of the surface smoothness. Moreover, when the cushion is particularly significantly deformed, the feel of increasing elasticity and friction at flexible thermally fixed points caused by the elastomer during large deformation is added to the smooth feel at the initial slipping, and an excellent feeling is obtained. Moreover, even when the cushion suffers large deformation repeatedly, the flexible thermally fixed points of the elastomer recover from the deformation. As a result, the elasticity is maintained, and the cushion shows excellent durability.

The method of forming a fiber ball of the present invention is explained below. Raw short fiber is blended so that a poly(trimethylene terephthalate) short fiber (b) that is a nonelastic short fiber and a conjugate short fiber (a) composed of a low melting point thermoplastic elastomer and a nonelastic polyester become in a given blended short fiber ratio (blending ratio of the conjugate short fiber (a) becoming from 5 to 49%), and the raw short fiber is well opened and blended with a card provided with a plurality of rollers each having a garnet wire on the surface to give bulky blended short fiber (uniformly and well blended). Fiber balls are formed in such an apparatus as explained below. The bulky blended short fiber is blown into a chamber of the apparatus where a rotary body having a plurality of fins is being rotated in a cylindrical space in which a turbulent airflow is likely to be generated, and the short fiber is agitated with a turbulent flow for a predetermined time to form fiber balls, which can be taken out. Alternatively, the bulky blended short fiber is retained in a chamber (large to a certain degree) while an air eddy current is being generated to form fiber balls. A crimped nonelastic short fiber and a conjugate short fiber (a) having partly a thermoplastic elastomer and being crimpable are thus uniformly blended to form entangled bulky blended short fiber. The bulky blended short fiber in which crimping is likely to proceed due to the properties of the conjugate short fiber readily forms fiber balls when suffered a force of air and a dynamic force. Furthermore, when the fiber balls are heat treated at temperatures of at least the melting point of the low melting point elastomer of the conjugate short fiber (a), thermoflexible thermally fixed points are formed in the fiber balls to give fiber balls that are excellent in elasticity, durability and feeling. Still furthermore, crimping also proceeds by heat treatment, and the action of readily forming fiber balls is likely to proceed. Any method can be used as long as the method causes such an action to make the fiber ball formation readily proceed. Moreover, when the nonelastic short fiber (poly(trimethylene terephthalate) short fiber) surface is more smooth and more slippery, the fibers are more easily formed into a ball. The following methods of forming the fiber balls can naturally be considered: a method comprising blowing hot air from at the initial stage of ball formation treatment, whereby ball formation, crimp manifestation and hot melt sticking (by melting the low melting point polymer) are simultaneously made to proceed; a method comprising treating the fibers at room temperature at the initial stage of the ball formation, and blowing hot air when the nuclei for the ball formation starts to form, whereby crimp manifestation and melt sticking take place; and a method comprising blowing gentle hot air after fiber balls are formed, whereby crimp manifestation and melt sticking are conducted.

In a particularly preferable case, the crimpability of a poly(trimethylene terephthalate) short fiber (b) that is a nonelastic short fiber is lower than that of a conjugate short fiber (a), and the nonelastic short fiber is likely to appear on the surface of the fiber ball. The nonelastic short fiber having a smooth surface thus appears on the fiber ball surface, and the fiber ball as a whole shows smoothness. Such fiber balls can be easily blown into a cushion, and the cushion into which the fiber balls are blown has an excellent soft feeling.

The conjugate short fiber (a) and the poly(trimethylene terephthalate) short fiber (b) that make a fiber ball of the present invention each have a fiber length of from 10 to 100 mm, preferably from 15 to 90 mm (suitable range). Moreover, the size of the fiber ball is from 2 to 15 mm in an average diameter, preferably from 3 to 13 mm (advantageous range).

The fiber balls themselves of the present invention explained above can be utilized as a cushion material and a pad. Moreover, the fiber balls are thermoformed in various molds such as a flat plate-like mold, and the resultant molded articles are used for chairs and seats. In other words, the fiber balls are thermoformed in a mold to be thermally adhered each other on the surface in a desired shape and give a cushion structure. FIG. 2 illustrates the method of producing the molded article and one embodiment of the apparatus.

FIG. 2 is a sectional view showing one embodiment of an apparatus for molding the molded article of the present invention. The reference numeral 1 designates a fiber ball supplying apparatus. Fiber balls 2 are blown through a blowing pipe 4 into a mold 3 from the supplying apparatus and packed therein. The mold 3 is an air-permeable one. When an airflow containing the fiber balls is blown into the mold, the balls alone are deposited within the mold. The air penetrates the mold, and is released outside. When the balls in a necessary amount are packed within the mold, hot air is blown into the mold, and the binder fiber (conjugate short fiber) within each ball hot melt sticks to another binder fiber and the matrix fiber (poly(trimethylene terephthalate) short fiber) to form a fiber molded structure. When the heating cycle is completed, the system is readily put into a cooling cycle, and the molded article is cooled and taken out of the mold to finish the thermoforming. The material of the gas-permeable mold used herein is preferably a stainless steel punching plate, or the like, in view of the thermoforming and the required stiffness. However, the material is not restricted thereto specifically. Moreover, when the releasability of the molded article after thermoforming is taken into consideration, the surface of the mold may also be made satin, or it may also be covered with a polytetrafluoroethylene (trade name of Teflon).

The molded article obtained as explained above has a 25% ILD measured in accordance with JIS K 6401 of preferably 11 N or less, more preferably from 5 to 10 N. The 25% ILD exceeding 11 N is not preferred because the feeling of the molded article becomes stiff, and the molded article used as a pillow cannot uniformly disperse a head pressure. Use of a fiber having a fine denier or lowering the blending ratio of the fiber that is the counter part of the conjugate fiber can make the 25% ILD 11 N or less.

Furthermore, the molded article of the invention shows a linearity measured by the method mentioned below of preferably 40% or less, more preferably from 25 to 35%. When the linearity exceeds 40%, the feeling of the molded article becomes stiff. Formation of a fiber ball in which the poly(trimethylene terephthalate) short fiber is used can make the linearity 40% or less. The linearity herein is measured during the measurement of an ILD in accordance with JIS K6401.

The molded article of the present invention, after washing three times (the washing specified by JIS L0217 103), shows a strain measured by the method described below of preferably 5% or less, more preferably from 0.5 to 3.0%. When the strain exceeds 5%, a change in shape after washing the molded article is significant. Formation of a fiber ball in which a poly(trimethylene terephthalate) short fiber is used can make the strain 5% or less.

The strain is obtained by measuring a change in thickness of the molded article in accordance with JIS K6401.

### EXAMPLES

The present invention is explained below by making reference to examples. In addition, the properties of samples in the examples are evaluated by the following methods.

Number of Crimp, Degree of Crimp

The number and the degree of crimp are measured in accordance with JIS L1015.

25% ILD, 50% ILD

Fiber balls experimentally prepared are packed in a side fabric (30 cm×30 cm) under a load of 1 g/cm² until the side fabric has a thickness of 5 cm, and the 25% or 50% ILD of the packed fiber balls is measured by utilizing the method in accordance with JIS K6401.

Linearity

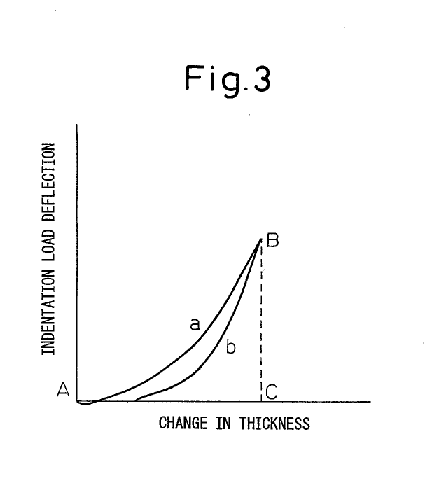

Measurement of the linearity is schematically shown in FIG. 3.

Thickness Strain after Washing

The thickness strain after washing is measured in accordance with JIS K6401.

In addition, samples after washing are allowed to stand for 20 hours to be naturally dried.

### Example 1

An acid component in which terephthalic acid and isophthalic acid were mixed in a ratio of 80/20 (mol %) and butylene glycol were polymerized to give a poly(butylene terephthalate) polyester. The polyester thus obtained in an amount of 40% by weight and 60% by weight of a poly(tetramethylene glycol) (molecular weight of 2,000) were heated and reacted to give a block copolymerized polyether polyester elastomer. The thermoplastic elastomer had a melting point of 157° C. The thermoplastic elastomer was used as a sheath, and a conventionally prepared poly(butylene terephthalate) (melting point of 224° C.) was used as a core. The polymer injection distribution of a special spinneret was adjusted so that the sheath/core weight ratio became 50/50. The sheath elastomer and the core polymer were then injected to give a conjugate short fiber. The conjugate short fiber was drawn with a draw ratio of 2.0. An emulsion of a segmented polymer of a poly(ethylene terephthalate) and a poly(ethylene oxide) was imparted to the drawn conjugate short fiber, and dried and solidified at 120° C. to manifest crimp. The short fiber was then cut to pieces 51 mm long. The conjugate short fiber thus obtained had a thickness of 3.3 dtex, a number of crimp of 10/inch and a degree of crimp of 15%.

Next, a poly(trimethylene terephthalate) short fiber to which steric crimp was imparted by anisotropic cooling was obtained. The short fiber had a thickness of 6.6 dtex, a fiber length of 64 mm, a number of crimp of 11/inch and a degree of crimp of 26%.

A roller card was passed twice so that the blended short fiber ratio of the conjugate short fiber to the poly(trimethylene terephthalate) short fiber became 10% by weight to 90% by weight, resulting in bulky blended short fiber. The short fiber was placed in an apparatus in which a blower and a short fiber storage box were connected with a duct. The short fiber was stirred with air by blower agitation for 30 seconds to provide short fiber in the form of fiber balls. The short fiber was then transferred to another short fiber storage box, and stirred with a weak airflow at 195° C., whereby flexible thermally fixed points were formed within each fiber ball while the elastic thermoplastic elastomer was being melted. Air at room temperature was subsequently blown into the box to give fiber balls after cooling. When the fiber balls were observed with a microscope, the poly(trimethylene terephthalate) short fiber was found on the surface of each ball with a probability of 90% by weight. Moreover, when the fiber balls were blown into a cushion side fabric with a blowing machine, no trouble with respect to blowing occurred. The cushion thus obtained had a soft feel, and showed excellent elasticity.

Next, the fiber balls were packed in a block-like gas-permeable mold, and thermoformed at 190° C. for 10 minutes to give a molded article. The molded article was evaluated, and the results are shown in Table 1.

### Example 2, Comparative Example 1

The procedure of Example 1 was repeated in Example 2 or Comparative Example 1 except that the type and proportion of the conjugate short fiber (a) and the poly(trimethylene terephthalate) short fiber (or the poly(ethylene terephthalate) short fiber) were changed. The results are shown in Table 1.

### Comparative Examples 2 to 4

In Comparative Example 2, 3 or 4, the conjugate short fiber (a) was used or not used, and the poly(trimethylene terephthalate) short fiber or the poly(ethylene terephthalate) short fiber was used to give a carded web. The carded web thus obtained was evaluated, and the results are shown in Table 1.

TABLE 1

| | Ex. | Ex. | C. Ex. | C. Ex. | C. Ex. | C. Ex. |
|---|---|---|---|---|---|---|
| | 1 | 2 | 1 | 2 | 3 | 4 |
| (Type of raw short fiber) | | | | | | |
| Conjugate short fiber (a) | 3.3 | 3.3 | 3.3 | 3.3 | 3.3 | — |
| thickness(dt)/fiber length | 51 | 51 | 51 | 51 | 51 | |
| (mm)/proportion(wt. %) | 10 | 10 | 10 | 10 | 10 | |
| PTT* short fiber | 6.6 | 2.2 | — | 6.6 | — | — |
| thickness(dt)/fiber length | 64 | 64 | | 64 | | |
| (mm)/proportion(wt. %) | 90 | 90 | | 90 | | |
| PET* short fiber** | — | — | 2.2 | — | 6.6 | 6.6 |
| thickness(dt)/fiber length | | | 51 | | 51 | 51 |
| (mm)/proportion(wt. %) | | | 10 | | 90 | 100 |
| Form of fiber structure | Ball | Ball | Ball | Carded | Carded | Carded |
| | | | | web | web | web |
| (Results) | | | | | | |
| 25% ILD (N/200φ) | 10.8 | 8.8 | 14.7 | 9.8 | 15.7 | 9.8 |
| 50% ILD (N/200φ) | 53.9 | 38.2 | 77.4 | 42.1 | 71.5 | 35.3 |
| Linearity (%) | 37 | 35.1 | 29.8 | 41.4 | 41.1 | 39.8 |
| Thickness strain(%) after | −2.3 | −4.5 | −2.9 | 3.4 | 3.0 | 4.9 |
| washing | | | | | | |

Note:
PTT* = Poly(tetramethylene terephthalate)
PET* = Poly(ethylene terephthalate)
**The poly(ethylene terephthalate) short fiber (polyester short fiber) used in Comparative Example 1 was a mechanically crimped conventional polyester staple fiber (number of crimp of 11/inch, degree of crimp of 15%). On the other hand, the polyester short fiber used in any one of Comparative Examples 3 to 4 was a latently crimpable polyester fiber, and was prepared by conjugate spinning two types of poly(ethylene terephthalate) different from each other in intrinsic viscosity, in a side-by-side manner. The polyester short fiber manifests crimp when heat treated (number of crimp of 11/inch, degree of crimp of 19%).

Fiber balls obtained in Example 1 or 2 were packed in a mold for bedding, a pillow, a cushion or a seat, and thermoformed at 190° C. for 10 minutes to produce bedding, a pillow, a cushion or a seat. The bedding, the pillow, the cushion or the seat thus obtained was excellent in elastic properties, durability, stress dispersibility and form stability.

### INDUSTRIAL APPLICABILITY

The molded article of the present invention is formed out of fiber balls. The fibers for the fiber ball are easily formed into the fiber ball due to the crimpability and the bending properties of the fibers. The fiber ball shows excellent elasticity and excellent durability such as compression durability due to the flexible thermally fixed points formed by heat treatment. The fiber ball further shows excellent properties about being blown into a side fabric and excellent handleability. Moreover, the fiber ball is excellent in stress dispersibility, shows isotropic compressibility and has a very soft feeling. The fiber ball is therefore very suitable as a material for cushions, pads, inner materials, and the like.

1. A molded article formed of highly elastic fiber balls and obtained by thermoforming fiber balls in a mold, characterized in that each fiber ball is composed of a conjugate short fiber (a) defined below and a poly(trimethylene terephthalate) short fiber (b), and that part of the fiber interlaced points of fibers of each fiber ball are thermally fixed with flexible thermally fixed points:
(a) a conjugate short fiber wherein a nonelastic polyester and an elastic thermoplastic elastomer having a melting point lower than that of the nonelastic polyester by 40° C. or more are combined, and the nonelastic polyester is exposed to occupy from 25 to 49% of the surface area of the conjugate short fiber.

2. The molded article formed of highly elastic fiber balls according to claim 1, wherein the poly(trimethylene terephthalate) short fiber (b) is a conjugate fiber formed by bonding two components in a side-by-side manner or in an eccentric core-sheath manner, at least one component is a poly(trimethylene terephthalate), and latent crimp is manifested.

3. The molded article formed of highly elastic fiber balls according to claim 1, wherein the individual fiber thickness of the poly(trimethylene terephthalate) short fiber (b) is from 1 to 7 dtex.

4. The molded article formed of highly elastic fiber balls according to claim 1, wherein the 25% ILD measured in accordance with JIS K6401 is 11 N or less.

5. The molded article formed of highly elastic fiber balls according to claim 1, wherein the linearity measured during measuring the hardness in accordance with JIS K6401 is 40% or less.

6. The molded article formed of highly elastic fiber balls according to claim 1, wherein the strain measured on the basis of a change in thickness in accordance with JIS K6401, after washing three times specified by JIS L0217-103 is 5% or less.

7. The molded article formed of highly elastic fiber balls according to claim 1, wherein the molded article forms bedding, a pillow, a cushion or a seat.
